(19) United States
(12) Patent Application Publication
(10) Pub. No.: US 2019/0013686 A1
(43) Pub. Date: Jan. 10, 2019

(54) MOBILE POWER SOURCE

(71) Applicant: EcoFlow Technology Limited, Shenzhen (CN)

(72) Inventors: Mingze MA, Shenzhen (CN); Fan ZHENG, Shenzhen (CN)

(21) Appl. No.: 15/807,131

(22) Filed: Nov. 8, 2017

(30) Foreign Application Priority Data
Jul. 7, 2017 (CN) 201720826850.6

(51) Int. Cl. H02J 7/00; G06F 3/01

(52) U.S. Cl. CPC H02J 7/0054; G06F 3/01; H02J 7/0045

(57) ABSTRACT

A mobile power source includes a housing, a rechargeable battery, a circuit board, an input interface, and a plurality of output interfaces. The housing is hollow and is shaped substantially as a box. The rechargeable battery is received in the housing. The circuit board is received in the housing and is electrically coupled to the rechargeable battery. The input interface is located on one side wall of the housing and is electrically coupled to the circuit board. At least partial output interfaces are located on the other side wall of the housing opposite to the side wall having the input interface, and the plurality of output interfaces are electrically coupled to the circuit board, respectively.

### CROSS REFERENCE TO RELATED APPLICATION

This application claims priority under 35 U.S.C. § 119 to Chinese Patent Application No. 201720826850.6, filed on Jul. 7, 2017, the entire content of which is incorporated herein by reference in its entirety.

### FIELD OF THE INVENTION

The present disclosure relates to the field of charging equipment, and more particularly relates to a mobile power source.

### BACKGROUND OF THE INVENTION

Mobile power source, also known as charge bank or travel charger, is a portable charger that integrates supplying power and charging functions. Many electronic products, such as mobile phones, tablet computers and other digital devices can use the mobile power source to charge anytime and anywhere, thereby bringing many convenience to people.

The current mobile power source has many interfaces thereon. There are generally three or four interfaces, and the mobile power source with larger capacity has more interfaces reaching more than ten or more. A variety of interface layout structures appeared on the market have the phenomenon of chaotic layout, causing inconvenience to use.

### SUMMARY

According to various embodiments of the present disclosure, a mobile power is provided.

A mobile power source includes a housing, a rechargeable battery, a circuit board, an input interface, and a plurality of output interfaces. The housing is hollow and is shaped substantially as a box. The rechargeable battery is received in the housing. The circuit board is received in the housing and is electrically coupled to the rechargeable battery. The input interface is located on one side wall of the housing and is electrically coupled to the circuit board. At least partial output interfaces are located on the other side wall of the housing opposite to the side wall having the input interface, and the plurality of output interfaces are electrically coupled to the circuit board, respectively.

These and other objects, advantages, purposes and features will become apparent upon review of the following specification in conjunction with the drawings.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. The accompanying drawings in the following description are only some embodiments of the present invention, and persons of ordinary skill in the art can derive other obvious variations from the accompanying drawings without creative efforts.

FIG. 1 is a perspective view of a mobile power source according to an embodiment;

FIG. 2 is similar to FIG. 1, but viewed from another aspect;

FIG. 3 is a top plan view of the mobile power source of FIG. 1;

FIG. 4 is a front view of the mobile power source of FIG. 1;

FIG. 5 is a rear view of the mobile power source of FIG. 1; and

FIG. 6 is a side view of the mobile power source of FIG. 1.

### DETAILED DESCRIPTION OF THE EMBODIMENTS

Embodiments of the invention are described more fully hereinafter with reference to the accompanying drawings. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art. Elements that are identified using the same or similar reference characters refer to the same or similar elements.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present. As used herein, the terms “left”, “right” and similar expressions used herein is for the purpose of describing particular embodiments only and is not intended to be limiting of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The term “and/or” as used herein includes any and all combinations of one or more of the associated listed items.

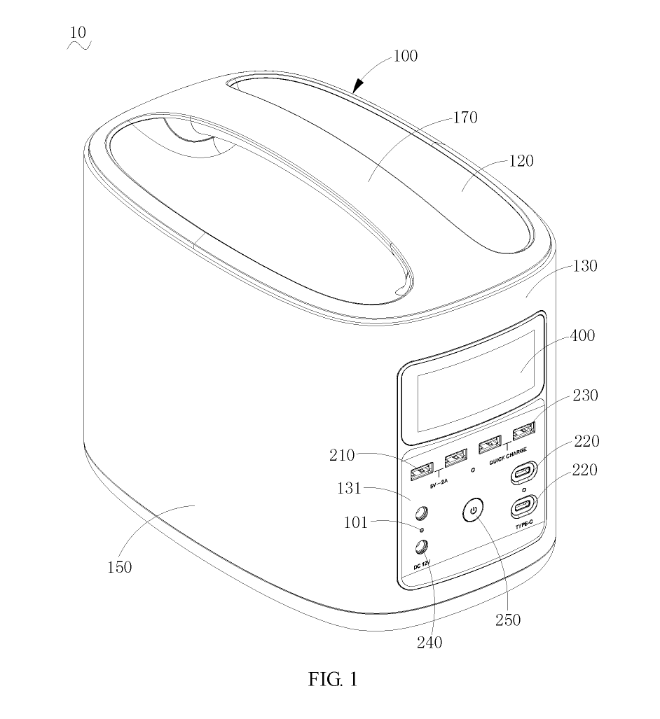

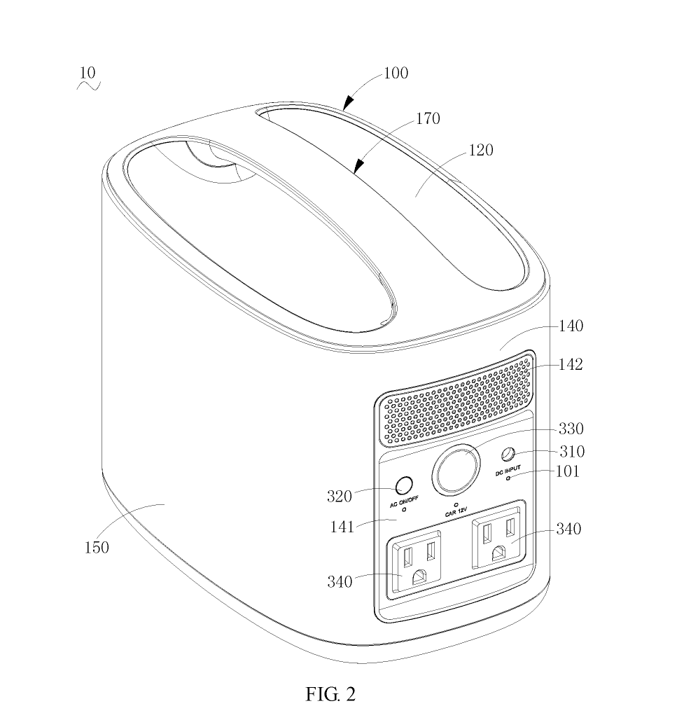

Referring to FIG. 1 and FIG. 2, a mobile power source 10 according to an embodiment includes a housing 100, and an input interface and a plurality of output interfaces located on side walls of the housing 100.

The housing 100 is a hollow structure. A rechargeable battery (not shown) and a circuit board (not shown) electrically coupled to the rechargeable battery are received in the housing 100. The rechargeable battery includes a plurality of battery packs arranged side by side. The input interface is located on one side wall of the housing 100 and is electrically coupled to the circuit board. The plurality of output interfaces is electrically coupled to the circuit board, respectively. At least partial output interfaces are located on the other side wall of the housing 100. As such, at least partial output interfaces are located on the other side wall of the housing 100 opposite to the side wall having the input interface, the side having a high frequency of use is disposed separately from the other side having a lower frequency of use, thus avoiding the inconvenience of using caused by the current mobile power source in which all interfaces are located on the same side, such that the overall interface layout is more reasonable, thereby conforming to application features of the mobile power source 10 and bringing greater convenience to user.

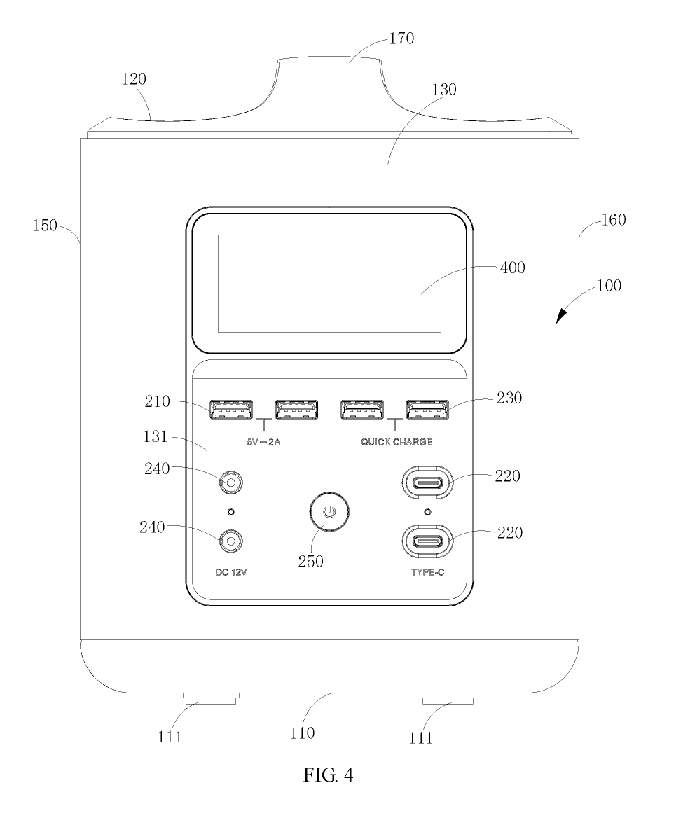

Referring to FIG. 1, FIG. 2, and FIG. 4, the housing 100 includes a bottom wall 110, a top wall 120 opposite to the bottom wall 110, a first side wall 130, a second side 140 opposite to the first side wall 130, a third side wall 150, and a fourth side wall 160 opposite to the third side wall 150. The first side wall 130, the second side wall 140, the third side wall 150, and the fourth side wall 160 are connected between the bottom wall 110 and the top wall 120. The four side walls are perpendicular to and connected to the bottom wall 110 and the top wall 120, respectively. The input interface is located on the second side wall 140, and at least partial output interfaces are located on the first side wall 130.

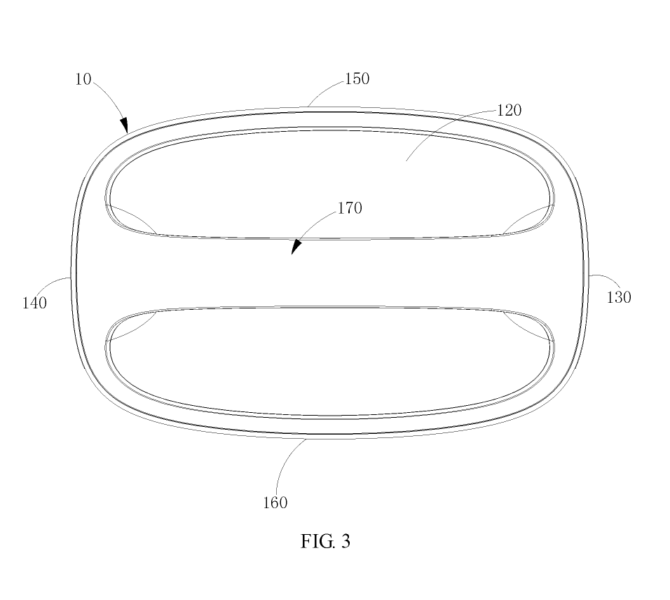

Referring to FIG. 1 to FIG. 3, in one embodiment, the housing 100 has an annular cross-section. A maximum width of the first side wall 130 is equal to a maximum width of the second side wall 140. A maximum width of the third side wall 150 is equal to a maximum width of the fourth side wall 160. The maximum width of the first side wall 130 is less than the maximum width of the third side wall 150.

The housing 100 has a substantially box shape as a whole. The outer side walls of the housing 100 are provided as arc surfaces, alternatively, the outer side walls of both sides symmetrical along the longitudinal direction are arc surfaces, and the remaining outer side walls are flat surfaces. The outer side walls of the mobile power source 10 have no corners, and the outer side walls of the entire mobile power source 10 are smoothly transitioned, which can effectively avoid scratching the user or scratching other objects during transporting or using, such that the overall appearance is more beautiful. The housing 100 may be provided with rounded corners at edges of a top and edges of a bottom thereof, so as to further increase the safety of its use.

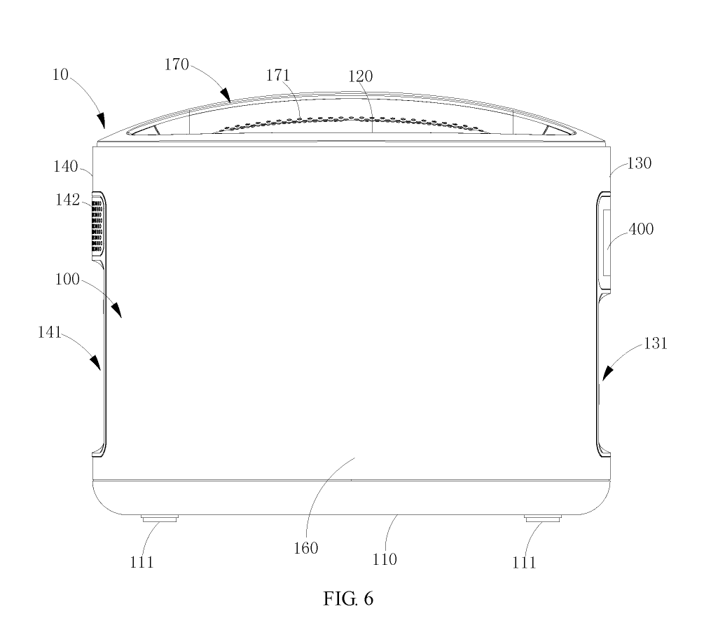

Referring to FIG. 1, FIG. 2, and FIG. 6, the first side wall 130 concavely defines a first groove 131, and the second side wall 140 concavely defines a second groove 141. The mobile power source 10 includes the plurality of output interfaces located in the first groove 131, and the input interface of the mobile power source 10 is located in the second groove 141. Bottom surfaces of the first groove 131 and the second groove 141 are flat surfaces and are parallel to a vertical surface. The first groove 131 and the second groove 141, on the one hand, can make the design of the plurality of output interfaces more neat, on the other hand, it is easy to observe the using situation of all interfaces on the same side wall.

A plurality of spaced interfaces, such as universal serial bus (USB) interfaces 210, or Type-C interfaces 220, Lighting interfaces (not shown), or quick charge interfaces 230 based on a quick charge protocol, such as quick charge interfaces based on quick charge 2.0, 3.0, or 4.0 protocols, or circular charge interfaces 240 may be located in the first groove 131 side by side. In alternative embodiments, most or all of the aforementioned interfaces may be located in the first groove 131.

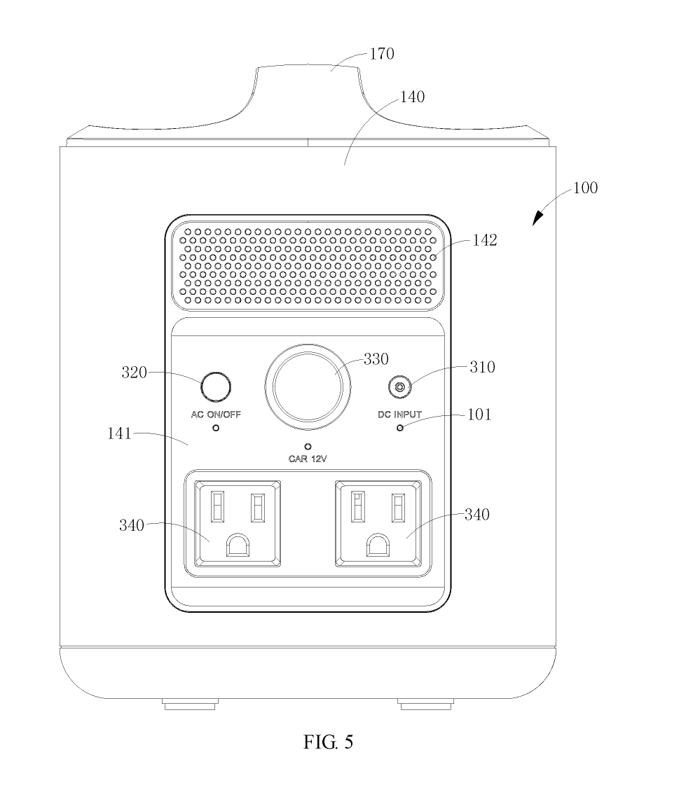

Referring to FIG. 1, FIG. 2, FIG. 4, and FIG. 5, in the illustrated embodiment, two USB interfaces 210 and two quick charge interfaces 230 based on the quick charge protocol horizontally spaced side by side are located in the first groove 131. Two Type-C interfaces 220 vertically spaced side by side are located in the first groove 131. Two circular charge interfaces 240 vertically spaced side by side are located in the first groove 131. There are labels in the vicinity of each type of interfaces configured to distinguish the interface types, such as printed text and/or patterns. The USB interface 210 can be USB 2.0 or USB 3.0 interface. An indicator lamp 101 is also located in the first groove 131, which is configured to display using situations of various types of interfaces. A switch 250 is located at a substantially central position of the first groove 131, and the switch 250 is configured to control on and off of a charge and discharge function of the mobile power source 10. Two circular charge interfaces 240 and two Type-C interfaces 220 are located at both sides of the switch 250, two USB interfaces 210 and two quick charge interfaces 230 based on the quick charge protocol are located above the switch 250. A direct current power input interface 310, an alternating current power input interface 320, an on-board input interface 330, and two 2P/3P receptacles are located in the second groove 141. 2P/3P receptacle can be directly used to supply power for external electronic equipment such as fans and musical instruments. Two jacks therein can also be used to charge the electronic device connected with an adapter.

It should be understood that, with the development of technology, some gradually antiquated, less frequently used, or slowly charged interfaces may be located on the second side wall 140. For example, the circular charge interface 240 may be located on the second side wall 140.

Referring to FIG. 1 and FIG. 4, in one embodiment, the first side wall 130 is provided with a display screen 400, which is electrically coupled to the circuit board. The display screen 400 may be disposed above the first groove 131, i.e., located adjacent to a top end of the housing 100. The display screen 400 may be configured to display a current status of use of the mobile power source 10, for example, a charging situation when the mobile power source 10 is charged, and a situation when the mobile power source 10 charges each external device. The output interfaces can be numbered, and the display screen 400 can simultaneously display the charging situation of the corresponding numbered external equipment. In other words, the display screen 400 also displays the number corresponding to the output interface.

Referring to FIG. 2 and FIG. 5, the second side wall 140 defines a plurality of heat dissipation holes 142 at an area above the second groove 141. The heat dissipation holes 142 may be, but are not limited to, circular holes.

Referring to FIG. 6, in one embodiment, the housing 100 is provided with a handle 170 at the top wall thereof. The handle 170 is provided with an anti-skid portion, which is disposed on a surface of the handle 170 opposite to the housing 100. The anti-skid portion may be a plurality of protrusions 171 and/or a plurality of ridges, which are formed on the handle 170, or may be a concave anti-skid groove.

Referring to FIG. 4, the housing 100 is provided with four support pads 111 at the bottom thereof, which are adjacent to four corners, respectively. The support pad 111 has a pie shape and may be made of plastic materials. Thicknesses of the four support pads 111 are equal, and the four support pads 111 are connected and fixed to the bottom of the housing 100 via screw, respectively. Both of the housing 100 and the handle 170 may be made of plastic materials. The housing 100 may be partially made of metals or lighter alloys, such as aluminum, and a portion of the housing 100 may be made of plastic materials, for example, the top and bottom thereof are made of plastic materials.

In the aforementioned mobile power source 10, at least partial output interfaces are located on the other side wall of the housing 100 opposite to the side wall having the input interface, such that the side having a high frequency of use is disposed separately from the side having a lower frequency of use, thus the inconvenience of using caused by the current mobile power source in which all interfaces are located on the same side can be avoided, the overall interface layout is more reasonable, thereby conforming to application features of the mobile power source 10 and bringing greater convenience to user.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

The foregoing descriptions are merely specific embodiments of the present invention, but are not intended to limit the protection scope of the present invention. Any variation or replacement readily figured out by a person skilled in the art within the technical scope disclosed in the present invention shall all fall within the protection scope of the present invention. Therefore, the protection scope of the present invention shall be subject to the protection scope of the appended claims.

What is claimed is:

1. A mobile power source, comprising:
a housing being hollow and shaped substantially as a box;
a rechargeable battery received in the housing;
a circuit board received in the housing and electrically coupled to the rechargeable battery;
an input interface located on one side wall of the housing and electrically coupled to the circuit board; and
a plurality of output interfaces, at least partial output interfaces being located on the other side wall of the housing opposite to the side wall having the input interface, the plurality of output interfaces being electrically coupled to the circuit board, respectively.

2. The mobile power source according to claim 1, wherein the housing has a bottom wall, a top wall opposite to the bottom wall, a first side wall, a second side opposite to the first side wall, a third side wall, and a fourth side wall opposite to the third side wall, the first side wall, the second side wall, the third side wall, and the fourth side wall are connected between the bottom wall and the top wall, the input interface is located on the second side wall, at least partial output interfaces are located on the first side wall.

3. The mobile power source according to claim 2, wherein the housing has an annular cross-section, a maximum width of the first side wall is equal to a maximum width of the second side wall, a maximum width of the third side wall is equal to a maximum width of the fourth side wall, the maximum width of the first side wall is less than the maximum width of the third side wall.

4. The mobile power source according to claim 2, wherein the output interface comprises at least one of a USB interface, a Type-C interface, a quick charge interface based on a quick charge protocol, a Lighting interface, and a circular charge interface, which are located on the first side wall.

5. The mobile power source according to claim 4, wherein the second side wall is provided with 2P/3P receptacle.

6. The mobile power source according to claim 4, wherein the first side wall is provided with a switch configured to control the mobile power source to be turned on and off.

7. The mobile power source according to claim 4, wherein the first side wall is provided with a display screen electrically coupled to the circuit board to display a current status of use of the mobile power source.

8. The mobile power source according to claim 2, wherein the input interface comprises a plurality of input interfaces, the input interface comprises a direct current power input interface and an alternating current power input interface, which are located on the second side wall.

9. The mobile power source according to claim 8, wherein the input interface further comprises an on-board input interface located on the second side wall configured to connect to an on-board power interface.

10. The mobile power source according to claim 2, wherein the housing is provided with a handle on the top wall thereof.
